(19) United States
(12) Patent Application Publication
(10) Pub. No.: US 2004/0007672 A1
(43) Pub. Date: Jan. 15, 2004

(54) Method for distinguishing between biomolecule and non-biomolecule crystals

(76) Inventors: Lawrence J. DeLucas, Birmingham, AL (US); Terry L. Bray, Birmingham, AL (US)

Correspondence Address: NEEDLE & ROSENBERG, P.C., SUITE 1000, 999 PEACHTREE STREET, ATLANTA, GA, 30309-3915, US

(21) Appl. No.: 10/617,292

(22) Filed: Jul. 10, 2003

Related U.S. Application Data
(60) Provisional application No. 60/395,108, filed on Jul. 10, 2002.

(51) Int. Cl. G01N 21/33

(52) U.S. Cl. 250/373; 356/326; 436/47

(57) ABSTRACT

A method for distinguishing between biomolecule and non-biomolecule crystals. The method comprises providing electromagnetic radiation to a sample comprising a crystal, allowing the electromagnetic radiation to interact with components of the crystal, and detecting effected changes, if any, in the quantity or character of the electromagnetic radiation, whereby a biomolecule crystal is capable of being distinguished from a non-biomolecule crystal. A device adapted for distinguishing between biomolecule and non-biomolecule crystals comprises a sample support, a source for a type of electromagnetic radiation, wherein the electromagnetic radiation can be provided to the sample, and a detector for the electromagnetic radiation wherein changes in the quantity or character of the electromagnetic radiation can be detected. The device can comprise more than one source of electromagnetic radiation for providing more than one type of radiation. The device can comprise more than one detector wherein each detector detects a different type of electromagnetic radiation.

### CROSS REFERENCE TO RELATED APPLICATIONS

This application claims priority to U.S. Provisional Application Ser. No. 60/395,108, filed Jul. 10, 2002, hereby incorporated by reference in its entirety.

### STATEMENT REGARDING FEDERALLY SPONSORED RESEARCH OR DEVELOPMENT

This invention was made with government support under NASA Grant NCC8246. The government may have certain rights in the invention.

### BACKGROUND OF THE INVENTION

1. Field of the Invention

The present invention generally relates to methods and devices for distinguishing between crystals of biomolecules, such as proteins and nucleic acids, and crystals of non-biomolecules. The present invention is particularly related to the method of distinguishing these crystals by examination of their effect on electromagnetic radiation. Even more particularly, the present invention is related to preferred techniques of measuring the effects of crystals of interest on absorbance of particular wavelengths of light and using the observed patterns of behavior to distinguish the nature or identity of the crystals.

2. Background

The crystallization of macromolecules, especially of biological macromolecules, is an important activity in many fields. Obtaining high quality crystals of any given macromolecule typically enables subsequent determination of the macromolecule's three dimensional structure (atomic configuration) using diffraction techniques. Of particular interest, the three dimensional structures so obtained can be of great use in the rational design of drugs or other therapeutics. Additionally, it is commonly accepted that one of the primary benefits that will flow from elucidation of the genome will be an improved understanding gained of the proteome, the entire set of expressed proteins in a particular biological organism. However, the full advantage that can be gained from that improved understanding of the proteome can only be realized with the knowledge of the three dimensional atomic configuration of each substituent protein. However, the process of obtaining structural data from crystals requires significant time, effort, and expense. The levels of resources required can be exacerbated by failures to focus attention on those crystals that will yield useful information.

One aspect of the effort required to maximize efficiency is to eliminate any excessive handling and attention of crystals that are not crystals of biomolecules. Regardless of the format used in the process of crystallization and study of crystals, including, but not limited to, multiwell plates, microarrays, chip-based devices, or other custom containment devices, it is necessary to discriminate between bona fide crystals of biomolecules and crystals of other materials such as salt, buffer, et cetera. In the past, researchers have tested individual crystals to see if they are fragile or robust and if they diffract strongly or not. Fragile crystals and those that did not diffract so strongly were taken to be protein crystals. However, each of these methods, and others used, require excessive amounts of time and effort by skilled technicians and are not readily adaptable to higher throughput methods.

Further, suspensions or solutions containing biomolecules and non-biomolecules are often encountered in a variety of experiments, analyses, and assays. In cases where such suspensions or solutions are found, it is often necessary to discriminate between those portions having greater biomolecule content and those having lesser biomolecule content. Such discrimination, particularly in circumstances where the components undergo or have undergone phase separations, such as occurs during crystallization, is difficult without extensive and invasive testing on the samples.

Also, besides usually being time consuming, such testing is often destructive and lessens the value to the original sample.

Correspondingly, a non-invasive method and device for assessing the composition of a sample in situ would prove useful.

### SUMMARY OF THE INVENTION

In accordance with the purpose(s) of this invention, as embodied and broadly described herein, this invention, in one aspect, relates to distinguishing between biomolecule and non-biomolecule crystals.

The invention includes a method for distinguishing between biomolecule crystals and non-biomolecule crystals comprising the steps of:

(a) providing electromagnetic radiation to a sample comprising a crystal of interest, wherein the electromagnetic radiation is of more than one type of electromagnetic radiation;

(b) allowing the electromagnetic radiation to interact with components of the crystal of interest; and

(c) detecting effected changes, if any, in the quantity or character of the electromagnetic radiation, whereby a biomolecule crystal can be distinguished from a non-biomolecule crystal.

The invention also includes a device adapted for distinguishing between biomolecule crystals and non-biomolecule crystals, comprising:

(a) a sample support, wherein a sample can be contained if provided;

(b) a first source for a first type of electromagnetic radiation, wherein the first type of electromagnetic radiation can be provided to the sample;

(c) a second source for a second type of electromagnetic radiation, wherein the second type of electromagnetic radiation can be provided to the sample;

(d) a first detector for the first type of electromagnetic radiation, wherein changes in the quantity or character of the first type of electromagnetic radiation can be detected; and

(e) a second detector for the second type of electromagnetic radiation, wherein changes in the quantity or character of the second type of electromagnetic radiation can be detected;

wherein the source for one type of electromagnetic radiation can be a source for one or more types of electromagnetic radiation and

wherein the detector for one type of electromagnetic radiation can be a detector for one or more types of electromagnetic radiation.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment(s) of the invention and together with the description, serve to explain the principles of the invention.

FIG. 1 is a schematic diagram of an embodiment of the screening device adapted for using visible and/or ultraviolet (UV) wavelength light.

FIG. 2 is a photograph showing an adaptation of the method. FIG. 2A shows an embodiment used to measure UV transmittance of crystals. FIG. 2B shows an embodiment used to measure visible transmittance of crystals.

FIG. 3 depicts a dried tetragonal lysozyme crystal and two NaCl crystals under visible light transillumination (A) and UV transillumination (B).

FIG. 4 depicts crystals of dried tetragonal lysozyme, NaCl, and sugar (sucrose) under visible light transillumination (A) and UV transillumination (B).

FIG. 5 depicts crystals of dried tetragonal lysozyme, thaumatin (tiny), NaCl, and sugar (sucrose) under visible light transillumination (A) and UV transillumination (B).

FIG. 6 depicts images of dried tetragonal lysozyme, thaumatin, NaCl, and sugar (sucrose) crystals: visible light illumination (A); UV illumination (B). The thaumatin crystal is in the upper right corner and looks surrounded by some material non-transparent for both UV and visible light.

### DETAILED DESCRIPTION

The present invention may be understood more readily by reference to the following detailed description of preferred embodiments of the invention and the Examples included therein, and to the Figures and their previous and following description.

Before the present compounds, compositions, articles, devices, and/or methods are disclosed and described, it is to be understood that this invention is not limited to specific methods, specific solutions, or to particular devices, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a precipitant” includes mixtures of a precipitant, reference to “a solution” includes combination of and/or mixtures of two or more such solutions, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

The present invention comprises a method and device for non-invasively determining the composition of samples containing multiple components. These samples can contain biomolecules and non-biomolecules that are used in a variety of applications. The present invention can discriminate between biomolecule and non-biomolecule components within samples in a non-invasive manner. The method can be adapted to exploit differences in absorption, transmission, or reflection characteristics of light directed at samples containing biomolecule and non-biomolecule components to determine the composition of matter within a sample. A device is also described with several embodiments for carrying out this method.

Biomolecules can contain types of substituents or ratios of substituents not found in non-biomolecules. These substituents can have characteristics in regard to their interaction with or effect on electromagnetic radiation that can be exploited to distinguish biomolecules from non-biomolecules or can be exploited to distinguish biomolecules from, under certain circumstances, other biomolecules having different amounts or types of substituents.

Biomolecules of interest typically contain chemical moieties that confer properties to the biomolecules that can be the basis for distinguishing biomolecules from non-biomolecules by their effect on electromagnetic radiation. For example, biomolecules contain components that absorb electromagnetic radiation in differing patterns from other biomolecules, organic molecules, or inorganic molecules. These differences in the pattern and/or degree of absorbance can be exploited to determine the presence or absence of a particular biomolecule in an object, such as, but not limited to a crystal. For example, proteins contain amino acid residues that will absorb electromagnetic radiation of specific wavelengths (e.g., ultraviolet light) to a greater degree than it will absorb others (e.g., visible light). In contrast, many inorganic (e.g., salt) or small organic (e.g., sucrose) compounds do not absorb appreciable amounts of either ultraviolet or visible light. Consequently, measurement of the absorbance (or transmittance), reflectance, or other influence on electromagnetic radiation of a particular character can be used to establish characteristics of an object of interest that are indicative of the character of the object of interest.

Method

In accordance with the purpose(s) of this invention, as embodied and broadly described herein, this invention, in one aspect, relates to a method for distinguishing between biomolecule crystals and non-biomolecule crystals.

In particular, in one aspect, the method comprises providing electromagnetic radiation to a sample that may or may not contain a crystal of interest, wherein the electromagnetic radiation can be of more than one type of electromagnetic radiation; allowing the electromagnetic radiation to interact with the crystal or components of the crystal of interest; and detecting effected changes, if any, in the quantity or character of the electromagnetic radiation, whereby a biomolecule crystal can be distinguished from a non-biomolecule crystal.

It is apparent to one of skill in the art that the method can be performed, for example, manually or in an automated fashion.

Electromagnetic Radiation

One of skill in the art can determine the type and amount of electromagnetic radiation to use in practice of the invention for a particular sample. The type and amount should not destroy or alter the sample of interest.

The types of electromagnetic radiation can vary from one another in respect to polarization or wavelength, for example. Correspondingly, the electromagnetic radiation can include radiation of at least two different wavelengths.

Examples of types of electromagnetic radiation that can be used include visible light and ultraviolet light.

The electromagnetic radiation is provided to the sample from a source. For example, visible light can be shown on the sample from a source of visible light, such as a lamp.

In one particular embodiment of the method, the provided electromagnetic radiation is ultraviolet and visible light and the effected changes detected are the relative absorption of ultraviolet light and the relative lack of absorption of visible light, which distinguish crystals causing the effected changes as being biomolecule crystals, as salt, sugar, and other non-biomolecule crystals typically do not preferentially absorb light in the ultraviolet region of the spectrum.

For example, proteins are biomolecules that contain amino acids, including those that absorb electromagnetic radiation with wavelengths of approximately 280 nanometers. This characteristic absorption can be used to distinguish crystals of protein from crystals of NaCl that do not absorb appreciable amounts of radiation of wavelengths of approximately 280 nanometers.

In general, both polypeptides and nucleic acids absorb light strongly in the ultraviolet (UV) region of the electromagnetic spectrum while non-biomolecules are typically transparent or absorb weakly in the UV region. As will be recognized by those of skill in the art, characteristic differences between biomolecules or subsets of biomolecules and either non-biomolecules or other subsets of biomolecules can be determined using electromagnetic radiation at other wavelengths besides those found within the ultraviolet and visible portion of the spectrum. Indeed, electromagnetic radiation of any wavelength(s) where differences in absorption, transmission, or reflection characteristics between biomolecule and non-biomolecule components can be measured are included in the present invention.

Further, if incident electromagnetic radiation is plane polarized, the relative optical activity at one, two, or more different wavelengths can be determined and can be utilized as the basis for distinguishing between biomolecules or subsets of biomolecules and either non-biomolecules or other subsets of biomolecules. For example, the optical rotatory dispersion (ORD) of a crystal of unknown character can be determined and compared to known or predicted ORDs of biomolecules or non-biomolecules to determine the character of the crystal. Similarly, the circular dichroism (CD) of an object (e.g., crystal) can be used. Teachings regarding obtaining and analyzing data that relate to both ORD and CD can be found in Biophysical Chemistry by Cantor and Schimmel, (1980, W. H. Freeman & Company, NY), all portions of which that relate to ORD and CD are incorporated herein by reference.

Sample

The sample can be any sample desired to be examined for crystals. One of skill in the art can determine the samples to be used in the method. For example, the sample can be a liquid which contains crystals or dry crystals.

The amount of sample that can be used in the method is any which is sufficient to provide data when used in the method of the invention. One of skill in the art can determine the amount of sample that can be used. The amount can vary depending on the equipment used, as some equipment combinations can be more sensitive than others (e.g., detectors). Examples of sample amounts are microliter, nanoliter, or picoliter volumes.

The sample can contain biomolecule crystals. Biomolecule crystals can include, for example, peptides, polypeptides, proteins, or materials containing peptides, polypeptides or proteins. Biomolecule crystals can also include, for example, nucleic acids such as RNA or DNA or fragments or portions thereof.

The sample can contain non-biomolecules crystals, for example, salt.

In certain embodiments, at least one biomolecule crystal is provided in a sample. In other embodiments, at least one non-biomolecule crystal can be provided. If a biomolecule crystal is provided, it can be a protein crystal or it can be a crystal containing nucleic acid.

In another embodiment, the method can be performed essentially simultaneously on multiple samples. Alternatively, the method could be performed sequentially on multiple samples. In an embodiment of essentially simultaneous performance on multiple samples, an example method can include providing the more than one sample, e.g., in a multiwell tray or microarray chip. The samples could be analyzed in parallel.

Allowing Electromagnetic Radiation to Interact with Crystal

The electromagnetic radiation is allowed to interact with the crystal or components of the crystal. For example, visible light can be shown on the sample for a period of time sufficient to observe or measure a change in absorbance (or transmittance) of the light, if a change is going to occur. If no interaction is allowed between the radiation and the crystal (or crystal component), any changes in radiation cannot be attributed to the crystal.

It is contemplated that there is an effected change in the quantity or character in the electromagnetic radiation of at least one of the types (e.g., wavelengths) when it contacts a crystal of interest or a subset of the crystals of interest. It will be recognized by those of skill in the art that so long as there is a difference in the effected changes between those crystals that are being distinguished from one another, the crystals that are to be distinguished can be distinguished on the basis of the observed effected changes in the electromagnetic radiation. For example, when the wavelengths are within the ultraviolet region of the spectrum and the visible region of the spectrum and significantly greater absorption in the ultraviolet spectrum than the visible spectrum occurs, this can indicate that the crystal is a biomolecule crystal. This would be in contrast to the example of if there is no significant absorption in either the ultraviolet region or visible region of the spectrum, this can indicate that the crystal is a non-biomolecule crystal.

Detecting Change

Effected change of the electromagnetic radiation is detected, if any change occurs.

Detection can be by any means sufficiently sensitive to detect changes in the radiation. One of skill in the art can determine appropriate detection means. Examples of detectors are the eye or a microscope with a CCD detector.

Measurement of the effect of an object of interest on more than one type of electromagnetic radiation can also be used. For example, measurement of the absorbance (or transmittance) of two or more particular wavelengths of electromagnetic radiation by an object of interest can be used to establish absorbance (or transmittance) ratios that are indicative of the character of the object of interest.

The established character of an object of interest can be used to distinguish a particular object as being distinct from another type of object. For example, establishing that a crystal is proteinaceous can be used to determine that the crystal is not a crystal of salt.

Further, the relative ratios of absorbance at multiple wavelengths can be used to determine characteristics of an object including, for example, whether the object contains a biomolecule. For example, the relative absorbance of electromagnetic radiation with wavelengths of approximately 280 nanometers compared to the relative absorbance across the visible spectra or at a specific wavelength of the visible spectrum can be determined for a crystal. If comparison of the resulting ratio or relationship between the absorbance in the ultraviolet region (e.g., with a wavelength of approximately 280 nanometers) and the absorbance in the visible region (e.g., with a wavelength of any wavelength between about 300 nanometers to about 700 nanometers) indicates a high degree of absorbance in the UV portion of the spectra and a low degree of absorbance in the visible portion of the spectra, the crystal can be determined to not be a typical salt crystal. Similarly, if the comparison indicates a low degree of absorbance in both the UV and visible portions of the spectra, the crystal can be determined to not be a typical protein or polypeptide crystal (certain polypeptides lacking any aromatic constituent might not absorb appreciable amounts of UV radiation).

In whatever manner the electromagnetic radiation is perturbed by the structure or composition of the object of interest (e.g., crystals), the measurement of the perturbation can be used to distinguish aspects about the character of the object of interest in a non-invasive manner. The ability of the current invention to distinguish between biomolecule crystals and non-biomolecule crystals is a significant advancement over the current state of the art in this field that requires matter within samples to be recovered and analyzed ex situ using techniques such as x-ray diffraction analysis to determine if the matter is composed of biomolecules or non-biomolecules. Thus, the present invention provides for a non-invasive, in situ method utilizing a single wavelength to image a sample or a multiple wavelength scan to generate a spectra with distinguishing features specific to the biomolecule within the sample or at least distinct from probable other substances potentially present.

It will be apparent to those skilled in the art that single-wavelength measurements or multiple wavelengths can be chosen so as to produce differences in the absorbed, transmitted or otherwise effected electromagnetic radiation such that the observed behavior is sufficiently unique to a given sample component as to determine the presence of the specified component within the sample. Non-limiting examples include the use of UV light at 280 nanometers wavelength, scans of multiple wavelengths to generate characteristic spectra, use of RAMAN spectroscopy methods within the present invention, and the use of evanescent wave methods within the present invention. The use of electromagnetic radiation and the distinctive patterns of behavior exhibited by electromagnetic radiation in response to the nature of objects allows characterization of crystals without direct physical contact. As the method of the present invention does not require physical contact between the crystal of interest and a probe or other such element, as is required for testing of crystals using conventional means, the current method is more amenable to automation than conventional methods now used to determine that a crystal is a protein crystal. Embodiments of the method that are automated are contemplated and provide for the rapid analysis of many samples in high throughput applications.

A particularly useful embodiment contemplated encompasses use of an analysis station that is used to monitor the absorbance (or other measurable parameters) of electromagnetic radiation by crystals in samples that are provided to the analysis station in an automated fashion.

Such a method can further include the sorting of crystals in regard to their determined characteristics. Such sorting can be of a physical nature (i.e., the samples containing the crystals are segregated according to the nature of crystals contained therein) or can be of an informational nature (i.e., the identity of samples containing crystals of a particular nature and/or the location of crystals of a particular nature within a sample are recorded).

Such methods can also include determination of the number of crystals or objects of specified character or identity within a given sample, set of samples, or other groups. Further, the number and identity relating to obtained crystals can also be used as a descriptor of conditions used to obtain crystals. For example, the total number of biomolecule crystals obtained and/or the fraction of crystals obtained that are biomolecule crystals can be used to describe results obtained using specific sets of conditions that can be used to form crystals.

An automated method can monitor sample or crystals within samples. The automated method can operate in response to a predetermined program. The predetermined program can include input or instructions from the user. Input or instructions can be provided prior to the screening process or can be provided during the screening process either in response to queries generated by the predetermined program or by the initiative of the user.

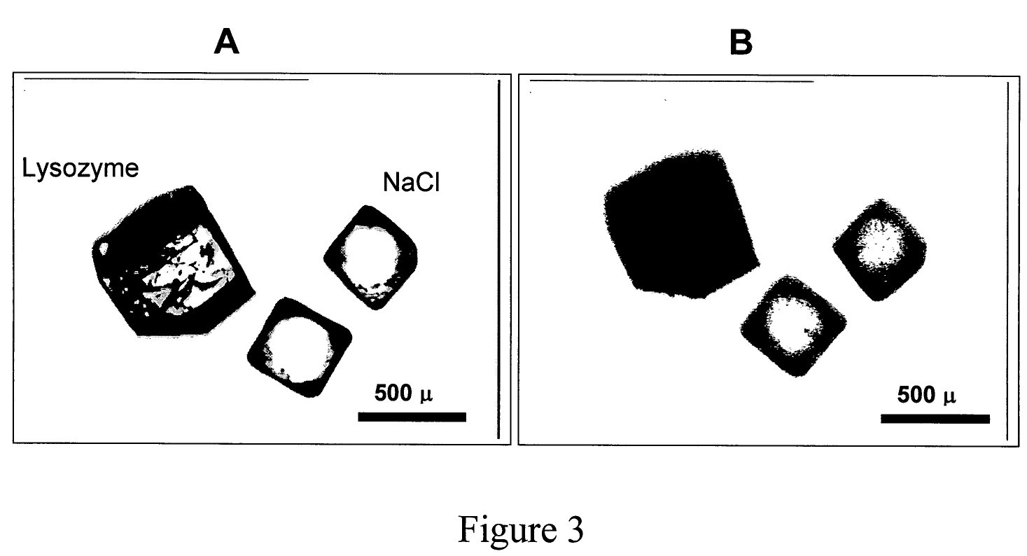

Data obtained from the method can include images and data sets representing images or data derived from both images or selected portions of images. Spectral images can be acquired automatically, with user action or with a combination of both automated and non-automated processes. Data so obtained can be analyzed using software developed for this method to determine the state of matter within a sample or plurality of samples. For example, images derived from visible and ultraviolet light absorbance images, like those in FIGS. 3-6 can be contrasted. One method to contrast these is to calculate the difference in intensity of absorbed radiation. In the case of UV and visible light, those regions of greatest difference can correspond to the presence of protein crystals, as is the case in FIGS. 3-6. Particular details regarding details of data analysis and calculations will, of course, vary depending on the characteristics of the materials being analyzed and upon the nature of the electromagnetic radiation employed. Optimization of such particular details are well understood by those of skill in the art and would be recognized not rise to the level of undue experimentation.

Device

In one aspect, the present invention provides a device (an analysis station) adapted for distinguishing between biomolecule crystals and non-biomolecule crystals. In particular, the device can include a sample support, wherein a sample can be contained if provided; a first source for a first type of electromagnetic radiation, wherein the first type of electromagnetic radiation can be provided to the sample; a second source for a second type of electromagnetic radiation, wherein the second type of electromagnetic radiation can be provided to the sample; a detector for the first type of electromagnetic radiation, wherein changes in the quantity or character of the first type of electromagnetic radiation can be detected; and a detector for the second type of electromagnetic radiation, wherein changes in the quantity or character of the second type of electromagnetic radiation can be detected.

As will be recognized by those of skill in the art, the source for one type of electromagnetic radiation can be a source for one or more types of electromagnetic radiation. Likewise, the detector for one type of electromagnetic radiation can be a detector for one or more types of electromagnetic radiation.

Sample Support

The device comprises a sample support. One of skill in the art can determine various embodiments of a sample support. The sample support supports or contains the sample when a sample is used with the device. The sample is discussed above in the METHOD section.

The shape and size of the sample support is not critical.

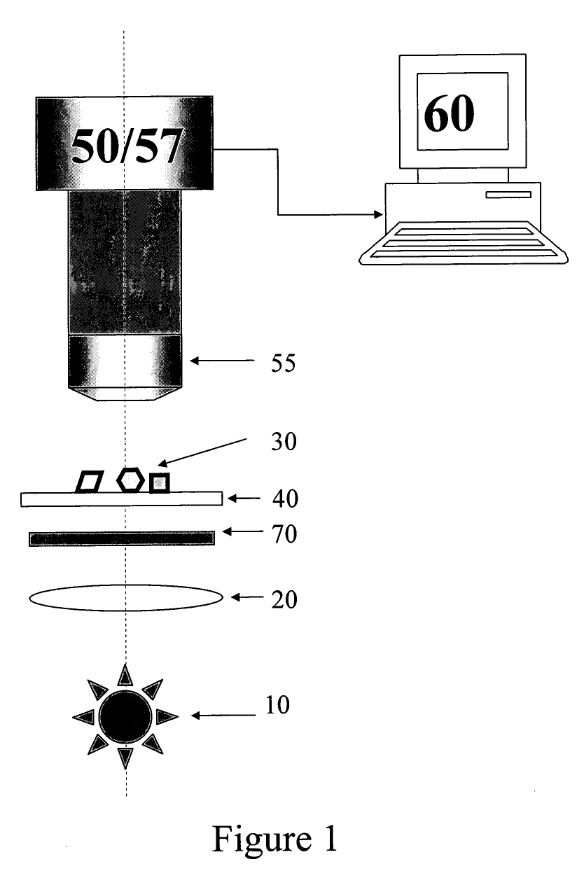

An example of a sample support is the sample plate 40 (quartz plate) of FIG. 1.

Source/Type of Electromagnetic Radiation

Electromagnetic radiation is discussed above in the METHOD section. Various types of electromagnetic radiation are also discussed.

The device comprises a source for electromagnetic radiation (for example, source 10 in FIG. 1). The device can comprise multiple sources of electromagnetic radiation, for example, a first source and a second source. For example, a light source can be a source of electromagnetic radiation. A light source can emit broad-spectrum or single wavelength electromagnetic radiation. Specifically, for example, an electromagnetic radiation source can be a halogen lamp or a deuterium lamp.

As will be appreciated, the source for one type of electromagnetic radiation can be a source for one or more types of electromagnetic radiation and the detector for one type of electromagnetic radiation can be a detector for one or more types of electromagnetic radiation (detectors are discussed below in the Detector section). Consequently, depending upon the specifics of the device employed, multiple devices or portions of a device may be required to provide more than one type of electromagnetic radiation or only a single device may be required.

In certain embodiments, a first type of electromagnetic radiation is light in the visible spectrum and a second type of electromagnetic radiation is ultraviolet light.

The type of electromagnetic radiation provided can be of a number of different types. For example, the first type of electromagnetic radiation can be polarized.

Detector

The device comprises a detector. One of skill in the art can determine various detectors which can be used. One of skill in the art will recognize that the selection of a detector can be based on its sensitivity to the radiation source, e.g., wavelength emitted by the source.

The detector detects the electromagnetic radiation. The detector can detect changes in the electromagnetic radiation. The detector can detect more than one type of radiation.

The detector can be, for example, an eye or a microscope 50 with a CCD detector 57 (such as in FIG. 1).

The device can comprise more than one detector. For example, the device can comprise a first detector for one type of radiation and a second detector for a second type of radiation.

Additional Components

The device of the invention can further comprise other components beyond sources for electromagnetic radiation and detectors. Examples of additional components are discussed below.

The device can comprise various components for directing a radiation source to the sample. The device can comprise a lens for focusing electromagnetic radiation. The device can comprise a light source coupled into a fiber optic cable to direct the radiation. The device can comprise a waveguide, e.g., contained within or adjacent to the sample container.

The device can include an automated system for providing a first sample and further samples to the sample support. If the device does include such an automated system, it can be such that it moves samples potentially containing crystals to be distinguished into the sample support and removes samples after electromagnetic radiation has been provided to the sample. The device can include an automated system wherein the device or a portion thereof can be positioned to provide electromagnetic radiation to a first sample and then repositioned to provide electromagnetic radiation to at least one further sample after electromagnetic radiation has been provided to the first sample. Similarly, the device can include an automated system wherein the device or a portion thereof can be positioned to detect changes in the quantity or character of at least one type of electromagnetic radiation caused by a first sample and then repositioned to detect changes in the quantity or character of at least one type of electromagnetic radiation caused by at least one further sample. As will be recognized by those of skill in the art, combinations of systems wherein both samples are moved and portions of the device are moved to provide the necessary irradiation of samples and detection of radiation influenced by samples are contemplated.

The device can also further include a recorder to record the changes in the quantity or character of the first and second types of electromagnetic radiation detected by the detectors of the apparatus. If the device does include a recorder, the recorder can be such that it compares the changes in the quantity or character of the first and second types of electromagnetic radiation to predetermined identifier values, whereby if the changes correspond to predetermined identifier values indicative of the identity of the examined crystal, the recorder generates a signal or record indicating the identity of the examined crystal. The recorder can also further include a memory function, wherein is recorded the identity and location of examined crystals. Alternatively, or in addition to the memory function, the device can further include a mechanism sorting mechanism, wherein examined crystals are sorted in accordance with the identity of the examined crystal. For example, the device, once it determines that a crystal is a salt crystal and not a biomolecule crystal can place the crystal in a receptacle and retain the crystal so that it does not further burden an automated structure determination assembly-line.

The device can be constructed in numerous variations and may be incorporated into other devices. For example, the device can be incorporated into a probe (e.g., utilizing elements such as fiber optics). Another example is the device can be fabricated onto or incorporated onto a chip-type configuration. A chip-type configuration can, for example, be fabricated using MEMS or MOEMS fabrication technology.

By way of non-limiting example, a device made to conduct the described method can comprise a light source emitting broad-spectrum or single-wavelength electromagnetic radiation. The light can then be directed into a region containing a sample and the absorbed, transmitted or reflected light can be measured by using a suitable detection device. A device of the invention can allow differences in absorbed, transmitted or reflected light throughout the sample to be measured. Measurement of those differences can allow determination of whether matter within the sample is composed of biomolecules or non-biomolecules.

The wavelength(s) is (are) selected such that the solution components interact with the selected wavelength with sufficient differences such that the amount of light absorbed or transmitted can produce measurable differences between selected components that are or could be contained within the sample. Transmitted, reflected or effected light can then be collected with an appropriate detector. An appropriate detector is one wherein it can detect the electromagnetic radiation transmitted, the electromagnetic radiation reflected or the effect on the electromagnetic radiation with sufficient sensitivity. The differences in, for example, absorption or transmission of light by sample components, allow determination of, for example, whether a crystal within the sample is composed of biomolecules or salt.

In an embodiment for essentially simultaneous measurement of multiple samples, the samples, e.g., provided in a multiwell tray or microarray chip, can be analyzed in parallel with an electromagnetic radiation source configured to introduce electromagnetic radiation to the samples essentially simultaneously. The electromagnetic radiation source can, for example, have a beam physically large enough to illuminate all samples. Alternatively, the electromagnetic radiation source can distribute electromagnetic radiation to each sample at each sample's location, e.g., with a fiber optic array or with multiple sources at the multiple sample locations. Similarly in this embodiment, the detector can be configured to detect the electromagnetic radiation from all samples essentially simultaneously or radiation can be detected by multiple detectors, e.g., one for each sample. Examples of detector configurations are a CCD detector with sufficient elements (pixels) to discriminate the effects of electromagnetic radiation on each sample, a fiber optic array, or detectors for each sample location.

As will be recognized by those of skill in the art, the present invention provides many advantages over the current state of the art. These advantages include but are not limited to:

(1) Non-invasive determination of whether matter within a sample is composed of biomolecules or non-biomolecules;

(2) Rapid determination of the state of matter in a sample;

(3) Automation of the method to enable use of this method in a high-throughput manner; and

(4) Use of this method on both biological and non-biological samples.

### EXAMPLE

The following example is put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

Discrimination between Protein and Non-Protein Crystals using UV and Visible Light

A device having an ultraviolet (UV) and visible (VIS) light source 10 is used. Light from the light source 10 is focused using a quartz lens 20 and sample crystals 30 are supported on a quartz plate 40. A CCD-equipped microscope 50, linked to a personal computer 60 to allow visual examination of sample crystals 30 is also provided. A UV filter 70 that can be placed between the light source 10 and the sample crystals 30 is also provided. Micrographs of sample plates with the UV light source 10 on (in this case, a deuterium lamp) and the UV filter 70 in, where the UV filter 70 blocks transmission of visible light are recorded to provide UV transilluminated images of crystals 30. Micrographs of sample plates with the visible light source 10 (in this case, a halogen lamp) on and where the UV filter 70 is not in place to block transmission of visible light are recorded to provide VIS transilluminated images of crystals 30.

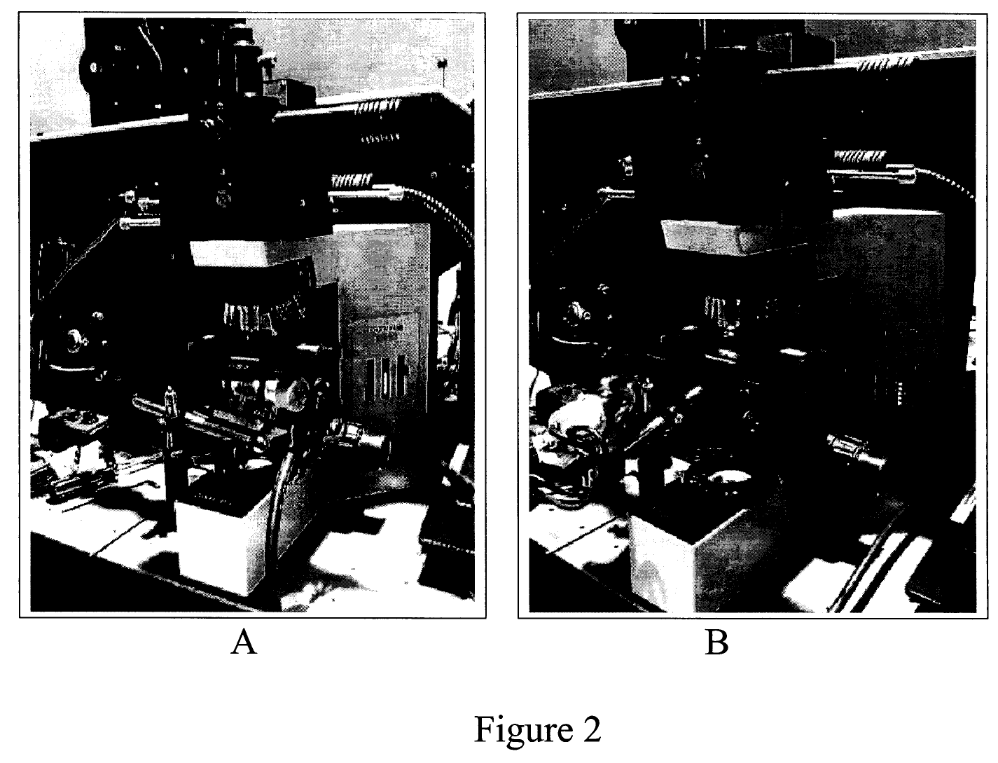

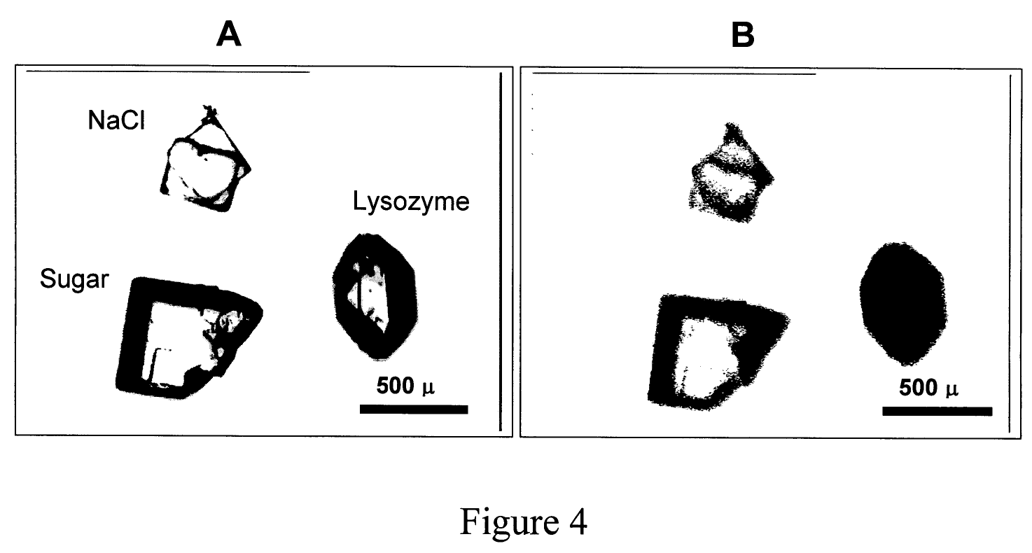

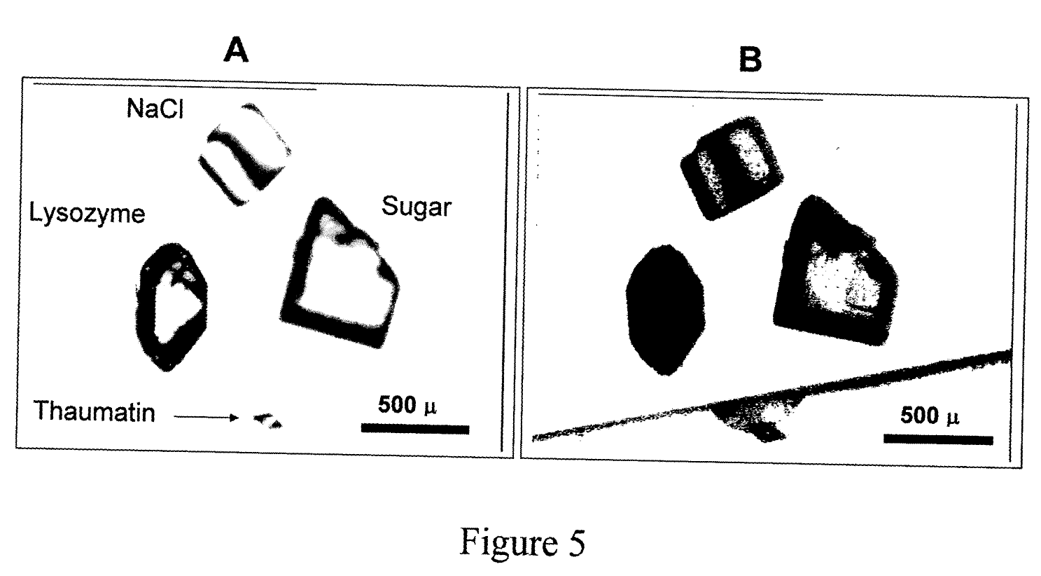

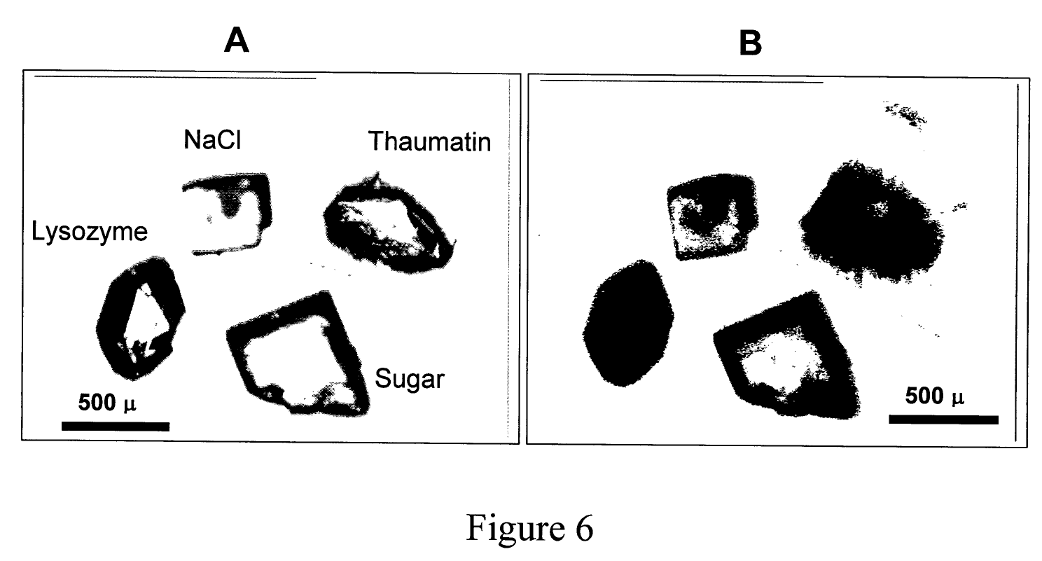

A schematic of the device is shown in FIG. 1. Photographs of the device set up to take the UV light measurement (FIG. 2A) and visible light measurement (FIG. 2B) are shown in FIG. 2. Characteristic results are shown in FIGS. 3-6. In FIG. 3, lysozyme and NaCl crystals are shown and distinguished. In FIG. 4, lysozyme, sugar (sucrose) and NaCl crystals are distinguished. In FIGS. 5 and 6, lysozyme, sugar (sucrose), NaCl, and thaumatin crystals are distinguished.

For the UV absorption measurements, a deuterium lamp 10 was used that had an emission spectrum starting at wavelengths less than 200 nm (continuous spectrum extends to ˜500 nm). For the visible light absorption measurements, the standard bottom illuminator 10 of the Olympus BX40 microscope 50 was used. This illuminator 10 is a halogen lamp that has a spectral response ranging in wavelengths from 350 to 800 nanometers.

The microscope objective 55 used, from an Olympus BX40 microscope 50, has a transmission of ˜1% at 300 nm (and probably close to zero at 280 nm). The CCD detector 57 is that with which the Olympus BX40 microscope 50 was equipped (WAT-202B by Watec) whose sensitivity at 280 nm is only a few percent of that in the visible region (400-700 nm). The regular wide band UV filter 70 was used for the UV filter 70. Its transmission spectrum ranges from 200 nm to 400 nm. The sample plate used 40 was the quartz plate 40 from a standard polarization rotator. Sample crystals 30 were placed on top of this plate 40. Quartz lens 20 were used to increase illumination intensity in sample area.

Samples used included lysozyme and thaumatin crystals. Some of these were partially or completely dried out. However, these crystals, like any other crystals of protein, contain intact the amino acid residues mainly responsible for absorption around 280 nm (Trp, Tyr, Phe).

The thaumatin crystals used in the experiment were obtained from the wall of a capillary tube. In obtaining these crystals, a small piece of glass (a chip) was removed with the crystals. Consequently, this chip of glass was present in some experiments. Protein crystals were mixed on a sample plate with salt (NaCl) and sugar (sucrose) crystals of the appropriate size to contrast the behavior of the protein (biomolecule) from non-protein (non-biomolecule) crystals.

As can be seen in the results are presented in FIGS. 3-6, where the images of protein (lysozyme and thaumatin), salt (NaCl) and sugar crystals in transmitted VIS and UV light are shown. It can be seen that protein crystals as it should be, strongly absorb UV light and look opaque in UV images (but translucent in VIS images). At the same time, salt and sugar (sucrose) crystals are translucent for both UV and VIS light.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for distinguishing between biomolecule crystals and non-biomolecule crystals comprising the steps of:
(a) providing electromagnetic radiation to a sample comprising a crystal of interest, wherein the electromagnetic radiation is of more than one type of electromagnetic radiation;
(b) allowing the electromagnetic radiation to interact with components of the crystal of interest; and
(c) detecting effected changes, if any, in the quantity or character of the electromagnetic radiation, whereby a biomolecule crystal can be distinguished from a non-biomolecule crystal.

2. The method of claim 1 wherein the more than one type of electromagnetic radiation vary from one another with respect to polarization.

3. The method of claim 1 wherein the more than one type of electromagnetic radiation vary from one another with respect to wavelength.

4. The method of claim 3 wherein the electromagnetic radiation of a) comprises radiation of at least two different wavelengths and wherein there is an effected change in the quantity or character in the electromagnetic radiation of at least one of the wavelengths.

5. The method of claim 4 wherein the wavelengths are within the ultraviolet region of the spectrum and the visible region of the spectrum and wherein significantly greater absorption in the ultraviolet spectrum than the visible spectrum indicates that the crystal is a biomolecule crystal.

6. The method of claim 1 wherein the crystal comprises a polypeptide.

7. The method of claim 1 wherein the crystal comprises a nucleic acid.

8. The method of claim 1 wherein the provided electromagnetic radiation of a) is ultraviolet and visible light and the effected changes of c) is the relative absorption of ultraviolet light and the relative lack of absorption of visible light, thereby distinguishing crystals causing the effected changes of c) as being biomolecule crystals.

9. A device adapted for distinguishing between biomolecule crystals and nonbiomolecule crystals, comprising:
(a) a sample support, wherein a sample can be contained if provided;
(b) a first source for a first type of electromagnetic radiation, wherein the first type of electromagnetic radiation can be provided to the sample;
(c) a second source for a second type of electromagnetic radiation, wherein the second type of electromagnetic radiation can be provided to the sample;
(d) a first detector for the first type of electromagnetic radiation, wherein changes in the quantity or character of the first type of electromagnetic radiation can be detected; and
(e) a second detector for the second type of electromagnetic radiation, wherein changes in the quantity or character of the second type of electromagnetic radiation can be detected;
wherein the source for one type of electromagnetic radiation can be the source for one or more types of electromagnetic radiation and
wherein the detector for one type of electromagnetic radiation can be the detector for one or more types of electromagnetic radiation.

10. The device of claim 9 wherein the first type of electromagnetic radiation is light in the visible spectrum and the second type of electromagnetic radiation is ultraviolet light.

11. The device of claim 9 further comprising at least one biomolecule crystal provided in a sample.

12. The device of claim 11 wherein the biomolecule crystal is a polypeptide crystal.

13. The device of claim 11 wherein the biomolecule crystal is a nucleic acid crystal.

14. The device of claim 9 wherein the first type of electromagnetic radiation is polarized.

15. The device of claim 9 further comprising an automated system for providing a first sample and further samples.

16. The device of claim 15 wherein the device moves samples potentially containing crystals to be distinguished into the sample support and removes samples after electromagnetic radiation has been provided to the sample.

17. The device of claim 9 further comprising an automated system for positioning at least one electromagnetic radiation source and at least one electromagnetic radiation detector to provide at least one type of electromagnetic radiation to the sample and to detect changes in the quantity or character of at least one type of electromagnetic radiation.

18. The device of claim 17 wherein the device is positioned to provide electromagnetic radiation to a first sample and then repositioned to provide electromagnetic radiation to at least one further sample after electromagnetic radiation has been provided to the first sample.

19. The device of claim 17 wherein the device is positioned to detect changes in the quantity or character of at least one type of electromagnetic radiation caused by a first sample and then repositioned to detect changes in the quantity or character of at least one type of electromagnetic radiation caused by at least one further sample.

20. The device of claim 9 further comprising a recorder to record the changes in the quantity or character of the first and second types of electromagnetic radiation detected by the detectors of the apparatus.

21. The device of claim 20 wherein the recorder compares the changes in the quantity or character of the first and second types of electromagnetic radiation to predetermined identifier values, whereby if the changes correspond to predetermined identifier values indicative of the identity of the examined crystal, the recorder generates a signal or record indicating the identity of the examined crystal.

22. The device of claim 21 wherein the device further comprises a memory function, wherein the identity and location of examined crystals are recorded.

23. The device of claim 21 wherein the device further comprises a sorting mechanism, wherein examined crystals are sorted in accordance with the identity of the examined crystal.

24. The device of claim 21 wherein the device further comprises a counting mechanism, wherein examined crystals of specified identity are counted.
